(19) United States
(12) Patent Application Publication
(10) Pub. No.: US 2026/0160218 A1
(43) Pub. Date: Jun. 11, 2026

(54) INTERNAL COMBUSTION ENGINE AND VEHICLE

(71) Applicant: Isuzu Motors Limited, Yokohama-shi (JP)

(72) Inventor: Kazaki KURATSUJI, Fujisawa-shi (JP)

(73) Assignee: Isuzu Motors Limited, Yokohama-shi (JP)

(21) Appl. No.: 19/403,308

(22) Filed: Nov. 28, 2025

(30) Foreign Application Priority Data
Dec. 9, 2024 (JP) 2024-214359

(51) Int. Cl. F02F 1/18; F16J 9/12

(52) U.S. Cl. CPC F02F 1/18; F16J 9/12

(57) ABSTRACT

An internal combustion engine includes: a cylinder and a piston. The cylinder includes an inner wall surface in which a plurality of first recesses are formed. The piston is disposed in an inside space covered by the inner wall surface. The piston includes a piston body, a piston ring, and a solid lubrication film. The piston ring is disposed on an outer peripheral surface of the piston body. The solid lubrication film is coated on an outer peripheral surface of the piston ring. The solid lubrication film changes, relative to a structure in which the solid lubrication film is not coated, a relationship between a moving speed of the piston and friction between a region in which the plurality of first recesses are formed in the inner wall surface and the piston ring.

### CROSS-REFERENCE TO RELATED APPLICATIONS

This application is based upon and claims the benefit of priority from Japanese Patent Application No. 2024-214359, filed Dec. 9, 2024, the entire contents of which are incorporated herein by reference.

### FIELD

The present disclosure relates to an internal combustion engine and a vehicle.

### BACKGROUND

Conventionally, it is known that friction between a piston that moves with respect to an inner wall surface of a cylinder provided in an internal combustion engine and the inner wall surface changes when a plurality of recesses are formed in the inner wall surface from a state in which the plurality of recesses are not formed in the inner wall surface. The piston moves at a low speed around the top and bottom dead centers, and moves at a high speed when facing the middle portion of the inner wall surface. Once the plurality of recesses are formed in the inner wall surface, an amount of friction reduction increases at a portion of the inner wall surface that faces the piston when the piston moves at a high speed with respect to the inner wall surface. The friction reduction amount varies depending on types of recesses such as a depth and shape of the recesses. When recesses of a specified type are formed, the friction reduction amount at the portion that faces the piston when the piston moves at a high speed with respect to the inner wall surface becomes larger than when recesses of another type are formed in the inner wall surface (for example, Jpn. Pat. Appln. KOKAI Publication No. 2017-26823).

### SUMMARY

An internal combustion engine includes: a cylinder and a piston. The cylinder includes an inner wall surface in which a plurality of first recesses are formed. The piston is disposed in an inside space covered by the inner wall surface. The piston includes a piston body, a piston ring, and a solid lubrication film. The piston ring is disposed on an outer peripheral surface of the piston body. The solid lubrication film is coated on an outer peripheral surface of the piston ring. The solid lubrication film changes, relative to a structure in which the solid lubrication film is not coated, a relationship between a moving speed of the piston and friction between a region in which the plurality of first recesses are formed in the inner wall surface and the piston ring.

### BRIEF DESCRIPTION OF THE DRAWINGS

FIG. 1 is a schematic diagram illustrating an example of a structure of a vehicle according to a first embodiment.

FIG. 2 is a schematic diagram illustrating an example of a structure of an internal combustion engine according to the first embodiment.

FIG. 3 is a cross-sectional view schematically illustrating, by a cross section, an example of a structure of an outer peripheral surface of a piston and the vicinity thereof according to the first embodiment.

FIG. 4 is a schematic diagram illustrating a structure of an inner wall surface of a cylinder according to the first embodiment.

FIG. 5 is a diagram for describing a plurality of recesses according to the first embodiment.

FIG. 6 is a diagram for describing a relationship between a speed of the piston including piston rings and friction between the piston and the inner wall surface in two cases, a case where piston rings according to the first embodiment are provided and a case where piston rings according to a comparative example are provided.

FIG. 7 is a diagram for describing a position and the like of the inner wall surface defined based on the speed of the piston including the piston rings according to the comparative example.

FIG. 8 is a diagram for describing a relationship between the speed of the piston and friction when each of the plurality of piston rings comes into contact with the inner wall surface in another contact mode different from a contact mode corresponding to the example shown in FIG. 6.

FIG. 9 is a schematic diagram illustrating a structure of an inner wall surface of a cylinder according to a second embodiment.

### DETAILED DESCRIPTION

### First Embodiment

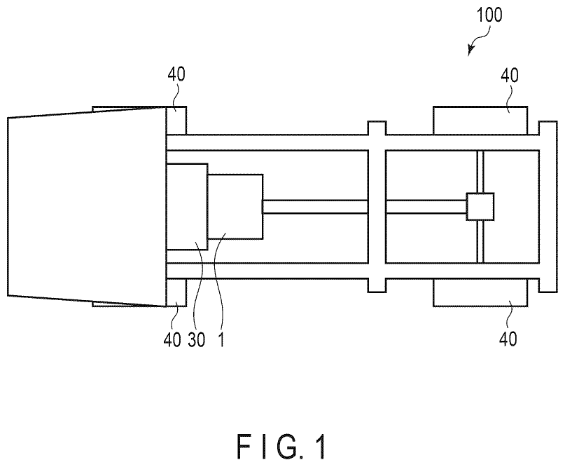

FIG. 1 is a schematic diagram illustrating an example of a structure of a vehicle 100 according to a first embodiment. As illustrated in FIG. 1, the vehicle 100 includes an internal combustion engine 1, a transmission 30, and at least one wheel 40. In the vehicle 100, once the internal combustion engine 1 is driven, a driving force is transmitted to the at least one wheel 40 via the transmission 30.

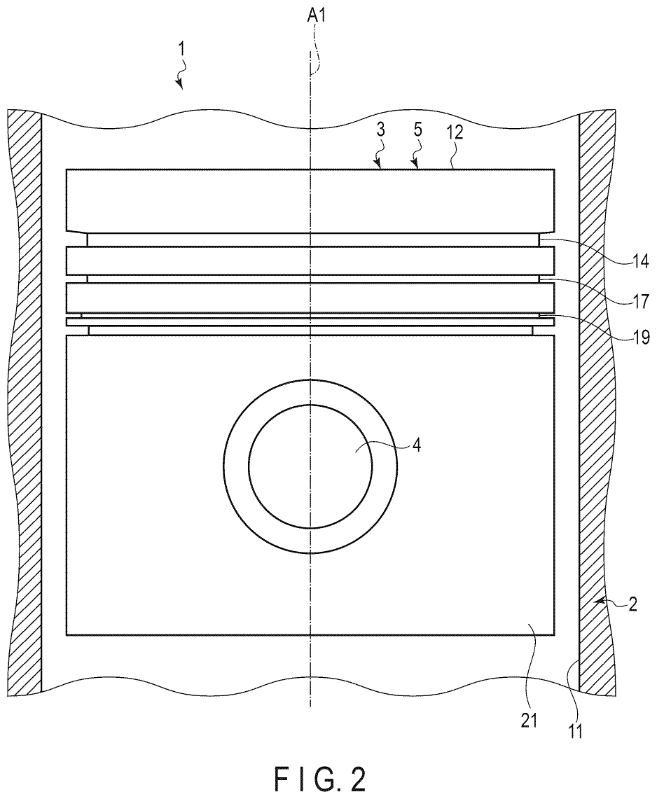

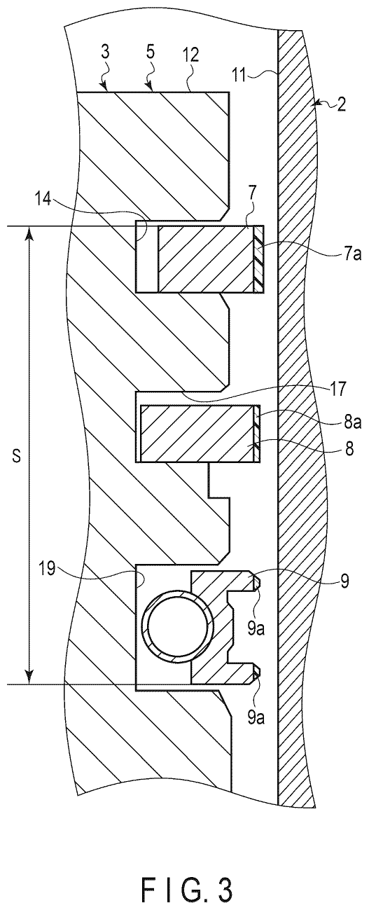

FIG. 2 is a schematic diagram illustrating an example of a structure of an internal combustion engine 1 according to the first embodiment. FIG. 3 is a cross-sectional view schematically illustrating, by a cross section, an example of a structure of an outer peripheral surface of a piston 3 and the vicinity thereof according to the first embodiment. As illustrated in FIG. 2 and FIG. 3, the internal combustion engine 1 includes a suction valve (not illustrated), a cylinder 2, the piston 3, a piston pin 4, a crank arm (not illustrated), and a crank shaft (not illustrated). The internal combustion engine 1 according to first embodiment is, for example, a 4-stroke engine that constitutes one cycle including four steps of suction, compression, expansion and exhaust. The internal combustion engine 1 according to the first embodiment is, for example, a diesel engine.

The cylinder 2 extends along a center axis A1 and is formed in a tubular shape such as a cylindrical shape. The cylinder 2 has an inner wall surface 11. In the cylinder 2, an inside space covered by the inner wall surface 11 is formed. Hereinafter, a direction around the center axis A1 of the cylinder 2 is defined as a circumferential direction. The inner wall surface 11 runs along the axial direction and the circumferential direction of the cylinder 2.

The piston 3 is disposed in the above-described inside space, and is coupled to the crank arm via the piston pin 4 or the like, which extends in a direction perpendicular to or substantially perpendicular to the center axis A1 of the cylinder 2. The crank arm is rotatably provided on the crank shaft. The piston 3 reciprocates along the center axis A1 of the cylinder 2 in the inside space in parallel with the rotation of the crank arm about the crank shaft. The axial direction of the cylinder 2 runs along a moving direction of the piston 3.

In the suction step of the internal combustion engine 1, the piston 3 descends toward the crank shaft side with respect to the suction valve, and reaches a bottom dead center. In the compression step, the piston 3 ascends toward the suction valve side from the bottom dead center, and reaches a top dead center. In the expansion step, the piston 3 descends to the bottom dead center once again. Then, in the exhaust step, the piston 3 ascends once again from the bottom dead center toward the suction valve side. In this manner, the piston 3 reciprocates between the top dead center and the bottom dead center.

Specifically, the piston 3 is stationary with respect to the inner wall surface 11 at the top dead center, and moves from the top dead center toward the bottom dead center while accelerating. The piston 3 transitions from acceleration to deceleration between the top dead center and the bottom dead center, and is stationary with respect to the inner wall surface 11 at the bottom dead center. Then, the piston 3 moves from the bottom dead center toward the top dead center while accelerating, transitions to deceleration between the top dead center and the bottom dead center, and is stationary with respect to the inner wall surface 11 at the top dead center.

The piston 3 includes a piston body 5 and a plurality of piston rings. In the piston body 5, for example, a piston top surface 12, a top ring groove 14, a second ring groove 17, an oil ring groove 19, and a piston skirt 21 are formed in that order from the suction valve side. The piston top surface 12 is an end surface on the suction valve side in the piston body 5, and faces toward the suction valve side. The piston skirt 21 forms an end surface on the crank shaft side in the piston body 5, and the end surface on the crank shaft side that the piston skirt 21 forms faces toward crank shaft side.

Each of the plurality of piston rings is disposed on an outer peripheral surface of the piston body 5. In one example, the plurality of piston rings include, for example, a top ring 7, a second ring 8, and an oil ring 9. The top ring 7 is disposed in the top ring groove 14. The second ring 8 is disposed in the second ring groove 17. The oil ring 9 is disposed in the oil ring groove 19.

A solid lubrication film is coated on each of the outer peripheral surfaces of the plurality of piston rings. The solid lubrication film is, for example, a diamond-like carbon film (DLC), a resin coating film, a molybdenum disulfide film, or the like. The outer peripheral surface of the top ring 7 is coated with a solid lubrication film 7a, the outer peripheral surface of the second ring 8 is coated with a solid lubrication film 8a, and the outer peripheral surface of the oil ring 9 is coated with a solid lubrication film 9a. Hereinafter, a region of the piston 3 between an edge of the top ring 7 on the suction valve side and an edge of the oil ring 9 on the crank shaft side is referred to as a region S.

In the first embodiment, the piston 3 used in the diesel engine, among internal combustion engines 1, is described as an example, but the embodiment is not limited to this. The piston 3 may be used in other internal combustion engines 1 such as a gasoline engine, in addition to the case where the piston 3 is used in the diesel engine.

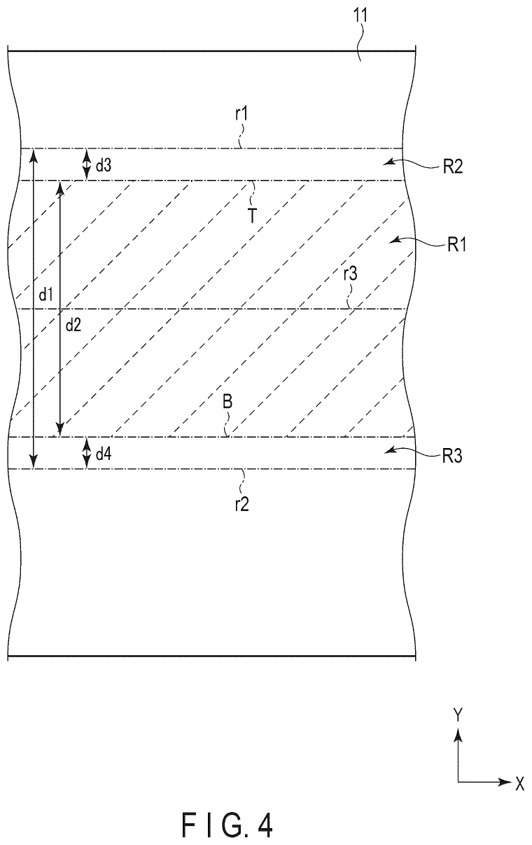

FIG. 4 is a schematic diagram illustrating a structure of an inner wall surface 11 of a cylinder 2 according to the first embodiment. FIG. 4 illustrates a state in which the cylinder 2 is developed and a part of the inner wall surface 11 is viewed from the inside space side covered by the inner wall surface 11 of the cylinder 2. A direction along the circumferential direction of the cylinder 2 is defined as an X-axis direction, and an axial direction along the center axis A1 of the cylinder 2 is defined as a Y-axis direction. In the Y-axis direction, the suction valve side is defined as a positive direction of the Y-axis direction and is referred to as an upper side. In addition, in the Y-axis direction, the crank shaft side is defined as a negative direction of the Y-axis direction and is referred to as a lower side. Here, a position of the inner wall surface 11 that faces the oil ring 9 when the piston 3 is located at the top dead center is defined as a first specified position r1. In addition, a position that faces the top ring 7 when the piston 3 is located at the bottom dead center is defined as a second specified position r2. As illustrated in FIG. 4, the first specified position r1 is located on the upper side with respect to the second specified position r2.

In the inner wall surface 11 according to the first embodiment, a plurality of recesses are formed. Hereinafter, in the first embodiment, a region in which the plurality of recesses are formed is referred to as a first region R1. Note that the phrase “forming a plurality of recesses in the inner wall surface 11” may be rephrased as “applying texturing to the inner wall surface 11.” In the first embodiment, recesses of one type are formed in the first region R1. The recesses formed in the first region R1 are of a type that, in a state in which the moving speed of the piston 3 is higher than the reference value, reduces friction between the piston 3 and the inner wall surface 11 as compared with other recesses that can be used instead of the recesses formed in the first region R1. The reference value is determined based on the relationship between the speed of the piston 3 and the friction between the piston 3 and the inner wall surface 11 in which the plurality of recesses are formed, and the relationship between the speed of the piston 3 and the friction between the piston 3 and the inner wall surface 11 in which other recesses are formed. In the following description, it is assumed that each of the plurality of piston rings is in constant solid contact with the recess during the reciprocating motion of the piston 3.

A top end T in the axial direction of the first region R1 to which texturing is applied is located on the lower side with respect to the first specified position r1. A bottom end B in the axial direction of the first region R1 is located on the upper side with respect to the second specified position r2. In FIG. 4, a distance between the first specified position r1 and the second specified position r2 along the axial direction is defined as d1 and a distance between the top end T and the bottom end B of the first region R1 along the axial direction is defined as d2. At this time, in one example, the distance d2 is in a range of 55% or more and 85% or less of the distance d1.

In FIG. 4, a distance between the top end T of the first region R1 and the first specified position r1 along the axial direction is defined as d3, and a distance between the second specified position r2 and the bottom end B along the axial direction is defined as d4. In one example, the distance d3 is the same or substantially the same as the distance d4.

The first embodiment is not limited to the structure in which the plurality of recesses are formed over the entire circumference of the inner wall surface 11 in the first region R1. In one example, the plurality of recesses do not need to be formed over the entire circumference of the inner wall surface 11 in the first region R1.

A region between the first specified position r1 and the second specified position r2 of the inner wall surface 11 according to the embodiment is, as illustrated in FIG. 4, divided into, for example, three regions of a first region R1, a second region R2, and a third region R3. The second region R2 corresponds to a region between the first specified position r1 and the top end T of the first region R1. The third region R3 corresponds to a region between the bottom end B of the first region R1 and the second specified position r2. The first region R1 is on the lower side with respect to the second region R2 and on the upper side with respect to the third region R3. The first region R1 and the second region R2 are continuous in the moving direction of the piston 3. In addition, the first region R1 and the third region R3 are continuous in the moving direction of the piston 3.

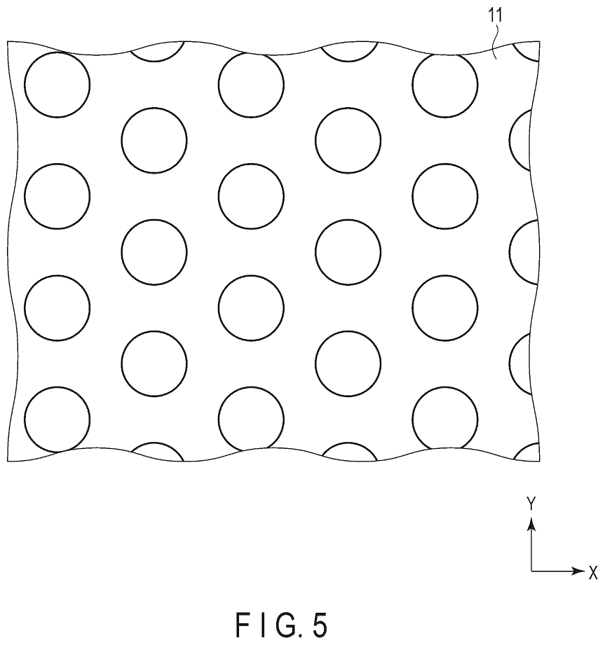

FIG. 5 is a diagram for describing a plurality of recesses according to the first embodiment. FIG. 5 illustrates a state in which a part of the first region R1 is viewed from the inside space side covered by the inner wall surface 11. Each of the plurality of recesses has, for example, a dimple shape. The embodiment is not limited thereto, and each of the plurality of recesses may have another shape. As illustrated in FIG. 5, in each of the plurality of recesses formed in the inner wall surface 11 according to the first embodiment, the opening has the same shape. The shape being the same includes, for example, that the shapes of the openings of the recesses are congruent, and that the difference in opening area of the recesses is small and the recesses are similar. In each of the plurality of recesses, the shape of the opening is, for example, a circular shape, and the diameter φ of the opening is, for example, 0.25 mm. The shape of the opening may be another shape such as a rectangular shape or a diamond shape.

Here, the arrangement of each of the plurality of recesses formed in the inner wall surface 11 according to the first embodiment will be described. In the first region R1, a plurality of recess rows are formed. The plurality of recess rows are formed offset from each other in the moving direction of the piston 3 from the top end T to the bottom end B of the first region R1. As illustrated in FIG. 5, in one example, the plurality of recess rows are arranged at a constant pitch along the moving direction.

In each of the plurality of recess rows, two or more recesses are arranged in the circumferential direction. Two or more recesses of the recess rows adjacent to each other in the moving direction of the piston 3 are arranged in a staggered manner. In one example, each of two or more recesses constituting an upper-side recess row of recess rows adjacent in the moving direction is positioned offset in the circumferential direction of the inner wall surface 11 with respect to each of two or more recesses constituting a lower-side recess row. In the first region R1, a recess row and a recess row adjacent to the recess row from the lower side in the moving direction of the piston 3 are alternately arranged.

In addition, in the recess rows adjacent to each other in the moving direction of the piston 3, the bottom end of the upper-side recess row is located below the top end of the lower-side recess row. Specifically, in the recess rows adjacent to each other in the moving direction of the piston 3, the bottom end of each of the two or more recesses constituting the upper-side recess row is located below the top end of each of the two or more recesses constituting the lower-side recess row. A phrase such as “the bottom end of the upper-side recess row being located below the top end of the lower-side recess row” may be rephrased as a phrase such as “overlapping each other in the axial direction.” In addition, if an area ratio of a plurality of recesses is defined as a value indicating a ratio of a total opening area of the plurality of recesses to the entire first region R1, in one example, the area ratio is 20% or more and 50% or less.

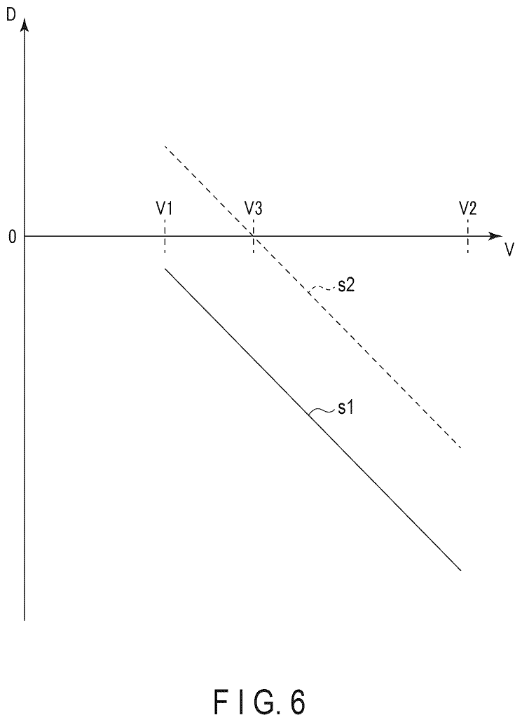

Next, the advantageous effects provided by the structure of the first embodiment will be described. FIG. 6 is a diagram for describing a relationship between the speed of the piston 3 including the piston rings and the friction between the piston 3 and the inner wall surface 11 in two cases of a case where the piston rings according to the first embodiment are provided and a case where the piston rings according to the comparative example are provided. In FIG. 6, the horizontal axis represents the speed of the piston 3 with respect to the inner wall surface 11, and the vertical axis represents the change amount D of the friction obtained by subtracting the friction when the recesses are not formed in the inner wall surface 11 from the friction when the recesses are formed in the inner wall surface 11. That is, when the change amount D is positive, as a result of formation of the recesses in the inner wall surface 11, the friction is increased as compared with the state in which the recesses are not formed in the inner wall surface 11. On the other hand, when the change amount D is negative, as a result of formation of the recesses in the inner wall surface 11, the friction is reduced as compared with the state in which the recesses are not formed in the inner wall surface 11. In the following description, in FIG. 6, V1 represents the speed of the piston 3 when the oil ring 9 passes through the top end T of the first region R1. At this time, the speed of the piston 3 when the top ring 7 passes through the bottom end B of the first region R1 is equal to or substantially equal to V1. The embodiment is not limited thereto, and in another example, V1 may represent the speed of the piston 3 when a piston ring other than the oil ring 9 passes through the top end T of the first region R1. In FIG. 6, V2 represents the maximum speed of the piston 3 when the piston 3 transitions from acceleration to deceleration. When the speed of the piston 3 is V1 or higher and V2 or lower, at least a part of the region S of the piston 3 faces the first region R1.

Here, a portion of the inner wall surface 11 that the second ring 8 faces when the speed of the piston 3 is V2 is defined as a third specified position r3. As illustrated in FIG. 4, the first region R1 is defined as a region including at least the third specified position r3. The third specified position r3 is not limited thereto, and may be defined as a position where the distance from the first specified position r1 along the moving direction of the piston 3 coincides or substantially coincides with the distance from the second specified position r2 along the moving direction of the piston 3.

In FIG. 6, a line segment s1 indicated by the solid line represents the change amount D with respect to the speed of the piston 3 including the piston rings coated with the solid lubrication film on the outer peripheral surfaces. As shown in FIG. 6, when the speed of the piston 3 is V1 or higher and V2 or lower, the change amount D is negative. Thus, when the piston 3 slides against the first region R1 in which the plurality of recesses are formed, the friction between the piston 3 and the inner wall surface 11 is reduced.

Here, an internal combustion engine 1 including piston rings not coated with a solid lubrication film on outer peripheral surfaces is described as a comparative example of the structure according to the embodiment. It is assumed that the structure of the internal combustion engine 1 according to the comparative example is the same as that according to the embodiment except for the structure of the piston rings. In FIG. 6, a line segment s2 indicated by the broken line represents the change amount D with respect to the speed of the piston 3 including the piston rings according to the comparative example not coated with the solid lubrication film on the outer peripheral surfaces. The line segment s1 indicated by the solid line and the line segment s2 indicated by the broken line represent the change amount D with respect to the speed of the piston 3 when the speed of the piston 3 is V1 or higher and V2 or lower.

As illustrated in FIG. 6, the line segment s2 intersects the straight line D=0. In FIG. 6, the speed of the piston 3 when the line segment s2 intersects the straight line D=2 is defined as V3. The speed V3 is smaller than V2 and greater than V1.

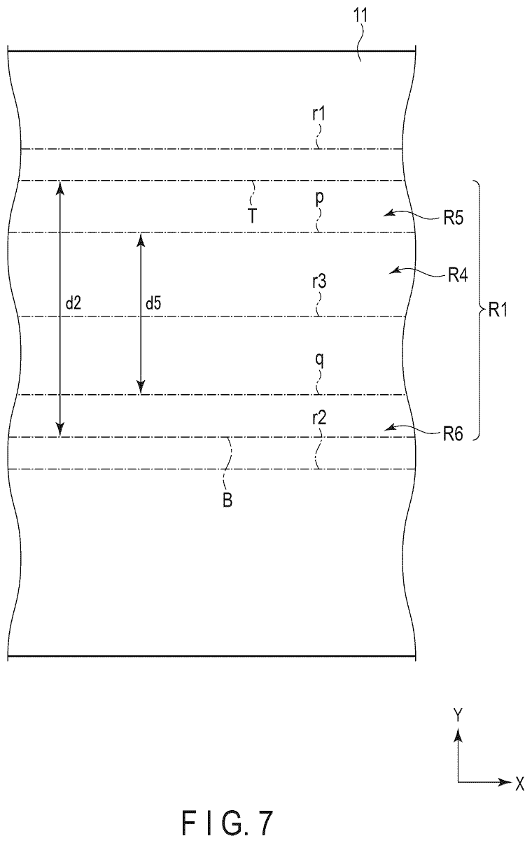

FIG. 7 is a diagram for describing a position and the like of the inner wall surface 11 defined based on the speed of the piston 3 including the piston rings according to the comparative example. As illustrated in FIG. 7, the first region R1 is divided into a fourth region R4, a fifth region R5, and a sixth region R6. The boundary between the fourth region R4 and the fifth region R5 is defined as a boundary p. The boundary between the fourth region R4 and the sixth region R6 is defined as a boundary q. The fourth region R4 is a region between the boundary p and the boundary q. The fifth region R5 is a region between the top end T of the first region R1 and the boundary p. The sixth region R6 is a region between the boundary q and the bottom end B of the first region R1. The distance between the boundary p and the boundary q along the axial direction of the cylinder 2 is defined as d5. The third specified position r3 is located between the boundary p and the boundary q.

In the following description, in FIG. 7, of the two portions facing the oil ring 9 when the speed of the piston 3 is V3, a portion located on the upper side with respect to the third specified position r3 will be described as the boundary p. In addition, of the two portions facing the top ring 7 when the speed of the piston 3 is V3, a portion located on the lower side with respect to the third specified position r3 will be described as the boundary q.

The speed V1 is smaller than V3, and as illustrated in FIG. 7, the top end T of the first region R1 is located on the upper side with respect to the boundary p, and the bottom end B of the first region R1 is located on the lower side with respect to the boundary q. Therefore, the distance d2 between the top end T and the bottom end B of the first region R1, which is the region provided with the recesses in the inner wall surface 11 according to the embodiment, along the axial direction of the cylinder 2 is greater than the distance d5 between the boundary p and the boundary q along the axial direction of the cylinder 2. That is, the fourth region R4 is narrower than the first region R1.

When the speed of the piston 3 is greater than V3 and V2 or lower, at least a part of the region S of the piston 3 faces the fourth region R4. In addition, when the speed of the V1 or higher and less than V3, the entire region S of the piston 3 faces the fifth region or the sixth region R6.

In another example, the boundary p may be a portion located on the upper side with respect to the third specified position r3 of the two portions facing the piston rings other than the oil ring 9 when the speed of the piston 3 is V3. Furthermore, in another example, the boundary q may be a portion located on the lower side with respect to the third specified position r3 of the two portions facing the piston rings other than the top ring 7 when the speed of the piston 3 is V3.

As shown in FIG. 6, when the speed of the piston 3 is greater than V3 and V2 or lower, the change amount D is negative. Therefore, when at least a part of the region S of the piston 3 faces the fourth region R4, the friction between the piston 3 and the inner wall surface 11 is reduced as compared with the condition in which no recess is formed in the inner wall surface 11.

On the other hand, when the speed of the piston 3 is V1 or higher and less than V3, the change amount D is positive. Therefore, when the entire region S of the piston 3 faces the fifth region R5 and when it faces the sixth region R6, the friction increases as compared with the condition in which no recess is formed in the inner wall surface 11. In the comparative example, although the friction is reduced when at least a part of the region S of the piston 3 slides against the fourth region R4, the friction increases when sliding against the fifth region R5 and when sliding against the sixth region R6. Consequently, the friction is not reduced in the entire first region R1.

In contrast, the outer peripheral surfaces of the piston rings according to the embodiment are coated with the solid lubrication film. When the solid lubrication film is coated, a relationship between the moving speed of the piston 3 and the friction between the region in which the plurality of recesses are formed and the piston ring changes. Specifically, when the piston rings are coated with the solid lubrication film, the friction when the region in which the plurality of recesses are formed and the piston rings are in solid contact is reduced. In the first embodiment, it is assumed that the plurality of piston rings are in constant solid contact with the plurality of recesses during the reciprocating motion of the piston 3. Thus, by changing the piston rings not coated with the solid lubrication film to the piston rings coated with the solid lubrication film, in FIG. 7, the relationship between the speed of the piston 3 and the friction between the piston 3 and the inner wall surface 11 is represented by the line segment s1, which is a parallel shift of the line segment s2 toward the negative direction. That is, when the piston ring is coated with the solid lubrication film, the friction is reduced as compared with the case when the piston ring is not with the solid lubrication film.

When the speed of the piston 3 including the piston rings coated with the solid lubrication film is V1 or higher and V2 or lower, the change amount D is negative as indicated by the line segment s1. Therefore, in the inner wall surface 11 according to the embodiment, the friction is reduced in the entire first region R1. Since the first region R1 is larger than the fourth region R4, the region in which the recesses can be formed can be made larger than in the inner wall surface 11 according to the comparative example, and it is possible to reduce friction at the portion of the inner wall surface 11 that faces the piston 3 when the piston 3 moves at a low speed with respect to the inner wall surface 11. Specifically, the distance along the axial direction of the cylinder 2 between the top end and the bottom end of the region in which the first recesses are formed can be set in a range of 55% or more and 85% or less of the distance along the axial direction of the cylinder 2 between the first specified position and the second specified position.

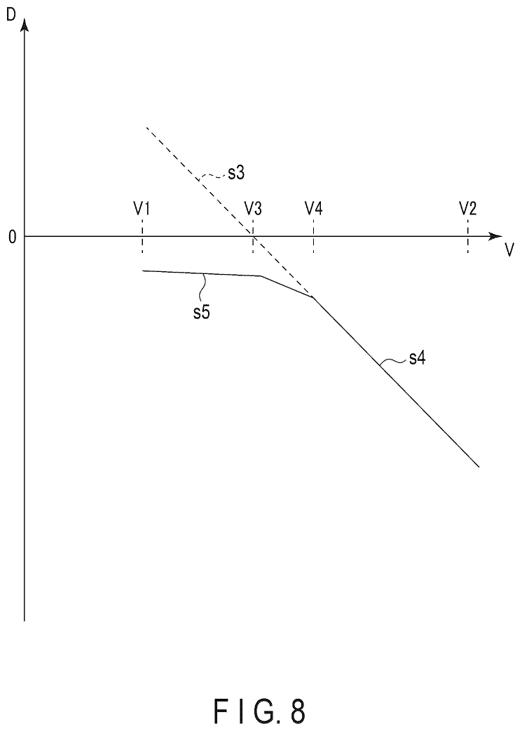

In the first embodiment, the case where each of the plurality of piston rings is in constant solid contact with the inner wall surface 11 during the reciprocating motion of the piston 3 has been described as an example, but a case where each of the plurality of piston rings is not in constant solid contact with the inner wall surface 11 but is in contact with the inner wall surface 11 in another contact mode is also conceivable. In this case, the relationship between the speed of the piston 3 and the friction is different from the case shown in FIG. 7. FIG. 8 is a diagram for describing a relationship between the speed of the piston 3 and the friction when each of the plurality of piston rings comes into contact with the inner wall surface 11 in another contact mode different from the contact mode corresponding to the example shown in FIG. 6. In FIG. 8, the speed of the piston 3 when the speed of the piston 3 is greater than V3 and less than V2 is defined as V4. A line segment s3 indicated by the broken line is the same as the portion of the line segment s2 shown in FIG. 6 in the range where the speed of the piston 3 is V1 or higher and less than V4. A line segment s4 indicated by the solid line is the same as the portion of the line segment s2 shown in FIG. 6 in the range where the speed of the piston 3 is V4 or higher and V2 or lower. A polygonal line s5 indicated by the solid line represents the relationship between the speed of the piston 3 and the friction in the case where each of the plurality of piston rings comes into contact with the inner wall surface 11 in another contact mode in the range where the speed of the piston 3 is V1 or more and less than V4. As indicated by the line segment s3 and the polygonal line s5, even when each of the plurality of piston rings comes into contact with the inner wall surface 11 in another contact mode, the friction between the piston 3 and the inner wall surface 11 is reduced in the range where the speed of the piston 3 is V1 or higher and less than V4.

### Second Embodiment

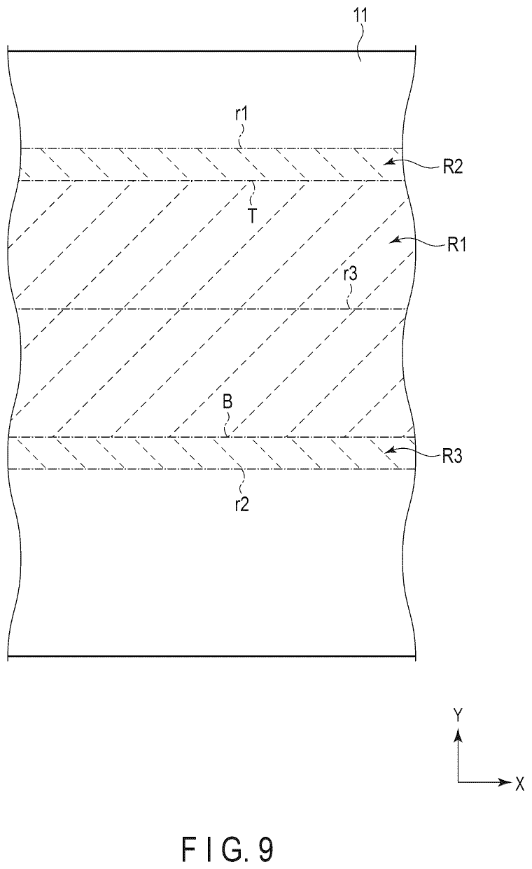

An internal combustion engine 1 according to the second embodiment has a structure in which in at least one of the second region R2 or the third region R3, recesses of a type different from the recesses formed in the first region R1 are formed. FIG. 9 is a schematic diagram illustrating a structure of an inner wall surface 11 of a cylinder 2 according to the second embodiment.

In the inner wall surface 11, a plurality of types of recesses are formed offset for each type in the moving direction of the piston 3. For the plurality of types of recesses, the influence on the relationship between the moving speed of the piston 3 and the friction between the inner wall surface 11 and the piston 3 is different for each type. In FIG. 9, in the first region R1 indicated by the broken lines extending with the inclination from the lower left to the upper right, as in the first embodiment, recesses of a type reducing the friction between the piston 3 and the inner wall surface 11 as compared with other recesses that can be used instead of the recesses formed in the first region R1 in a state in which the moving speed of the piston 3 is the reference value or higher are formed. Hereinafter, the recesses formed in the first region R1 are referred to as first recesses. In addition, in at least one of the second region R2 or the third region R3 indicated by the broken lines extending with the inclination from the bottom right to the top left, recesses of one or more types, having an influence different from that of the first recesses on the relationship between the moving speed of the piston 3 and the friction, are formed. Hereinafter, the recesses of one or more types formed in at least one of the second region R2 or the third region R3 are referred to as second recesses. The first recesses are, as compared with the second recesses of one or more types, of a type that reduces friction in a state in which the moving speed of the piston 3 is the reference value or higher. On the other hand, the second recesses are, as compared with the first recesses, of a type that reduces friction in a state in which the moving speed of the piston 3 is lower than the reference value.

In one example, in the inner wall surface 11, for example, recesses of two types are formed. The first recesses are formed in the first region R1, and the second recesses of one type are formed in the second region R2 and the third region R3. Thus, the recesses of two types are formed in the entire region between the first specified position r1 and the second specified position r2. The reference value is, for example, the speed when the piston 3 passes through the top end T of the first region R1 or the bottom end B of the first region R1.

The depth of the first recess is formed to be greater than the depth of the second recess. The depth of the first recess is, for example, 3.0 μm or more and 5.0 μm or less, and the depth of the second recess is, for example, 1.0 μm or more and 2.0 μm or less.

The embodiment is not limited to the above-described example, and it is also possible to adopt a structure in which no recess is formed in the third region R3 and the second recesses are formed only in the second region R2. It is also possible to adopt a structure in which no recess is formed in the second region R2 and the recesses are formed only in the third region R3.

Furthermore, the second recesses of two or more types may be formed in the second region. At this time, in the second region, recesses of a type reducing friction under lower-speed movement of the piston 3 are formed at positions farther from the first region R1. In addition, in the third region, recesses of a type reducing friction under lower-speed movement of the piston 3 are formed at positions farther from the first region R1.

According to the second embodiment described above, the first recesses are formed in the first region R1. In addition, in at least one of the second region R2 or the third region R3, the second recesses of one or more types, having an influence different from that of the first recesses on the relationship between the moving speed of the piston 3 and the friction between the inner wall surface 11 and the piston ring, are formed. Specifically, in the first region R1, the first recesses of a type reducing friction under high-speed movement of the piston 3 as compared with any of the second recesses of one or more types are formed. In addition, in at least one of the second region R2 or the third region R3, recesses of a type reducing friction under low-speed movement of the piston 3 as compared with the first recesses are formed. Thus, it is possible to further reduce the friction at the portion of the inner wall surface facing the piston 3 when the piston 3 moves at a low speed with respect to the inner wall surface 11.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An internal combustion engine comprising:
a cylinder including an inner wall surface in which a plurality of first recesses are formed; and
a piston disposed in an inside space covered by the inner wall surface,
the piston including:
a piston body;
a piston ring disposed on an outer peripheral surface of the piston body; and
a solid lubrication film coated on an outer peripheral surface of the piston ring,
wherein the solid lubrication film changes, relative to a structure in which the solid lubrication film is not coated, a relationship between a moving speed of the piston and friction between a region in which the plurality of first recesses are formed in the inner wall surface and the piston ring.

2. The internal combustion engine according to claim 1, wherein
the piston ring includes a top ring and an oil ring located on a lower side with respect to the top ring,
in the inner wall surface, a first specified position as a position facing the oil ring when the piston is located at a top dead center and a second specified position as a position facing the top ring when the piston is located at a bottom dead center are defined,
a top end of a region in which the plurality of first recesses are formed is located on the lower side with respect to the first specified position,
a bottom end of the region in which the plurality of first recesses are formed is located on an upper side with respect to the second specified position, and
a distance between the top end and the bottom end along an axial direction of the cylinder is 55% or more and 85% or less of a distance between the first specified position and the second specified position along the axial direction.

3. The internal combustion engine according to claim 1, wherein
the inner wall surface includes a first region in which the plurality of first recesses are formed, a second region on an upper side with respect to a top end of the first region, and a third region on a lower side with respect to a bottom end of the first region, and
in at least one of the second region or the third region, second recesses of one or more types are formed, the second recesses having an influence, different from the first recesses, on a relationship between the moving speed of the piston and friction between the inner wall surface and the piston ring.

4. The internal combustion engine according to claim 3, wherein
the plurality of first recesses are, as compared with the second recesses of one or more types, of a type reducing the friction under a condition in which the moving speed of the piston is a reference value or higher, and
the second recesses of one or more types are, as compared with the first recesses, of a type reducing the friction under a condition in which the moving speed of the piston is less than the reference value.

5. A vehicle comprising the internal combustion engine according to claim 1.
